(19) United States
(12) Patent Application Publication
(10) Pub. No.: US 2020/0392434 A1
(43) Pub. Date: Dec. 17, 2020

(54) GEL-STATE DETERGENT COMPOSITION AND DETERGENT PRODUCT

(71) Applicant: DAIO PAPER CORPORATION, Shikokuchuo-shi, Ehime (JP)

(72) Inventor: Kosuke YAMAZAKI, Shikokuchuo-shi (JP)

(73) Assignee: DAIO PAPER CORPORATION, Shikokuchuo-shi, Ehime (JP)

(21) Appl. No.: 16/977,501

(22) PCT Filed: Mar. 27, 2019
(86) PCT No.: PCT/JP2019/013196

§ 371 Date: Sep. 2, 2020

(30) Foreign Application Priority Data
Mar. 30, 2018 (JP) 2018-067667

(51) Int. Cl. C11D 17/00; C11D 11/00; C11D 3/22; B65D 35/10

(52) U.S. Cl. CPC C11D 17/003; B65D 35/10; C11D 3/222; C11D 11/0023

(57) ABSTRACT

A gel-state detergent composition which includes cellulose nanofibers, a surfactant, and water. The content of the cellulose nanofibers is preferably 0.02-0.2 mass %. The cellulose nanofibers have an average fiber width of preferably 30-50 nm. Due to this, a gel-state detergent composition which has high fixability to the inner surface of a toilet bowl, etc. and is easy to squeeze out of the container can be provided.

### TECHNICAL FIELD

The present invention relates to a gel-state detergent composition and a detergent product.

### BACKGROUND ART

Various detergents have been used for removing dirt attached to a site where water regularly flows, such as a toilet bowl or the like, and as one embodiment of the detergents, a detergent that is fixed on an inner surface of a toilet bowl or the like and is gradually dissolved out with flowing water in a toilet or the like for exhibiting the cleaning effect for a long period of time has been developed. The detergent is a gel-state detergent stored in a squeezable container, and is fixed to the inner surface of the toilet bowl or the like in use (see, for example, PLT 1).

### CITATION LIST

### Patent Literature

PTL 1: JP-A-2011-57780

### SUMMARY OF INVENTION

### Technical Problem

The gel-state detergent fixed to the inner surface of the toilet bowl or the like in use is demanded to have high fixability to the inner surface of the toilet bowl or the like, for exhibiting the cleaning effect for a long period of time. For enhancing the fixability, the viscosity is desirably high.

However, while the detergent of this type is necessarily squeezed out from the container by the user and then fixed to the inner surface of the toilet bowl or the like, the excessively high viscosity thereof may makes the squeezing operation difficult.

An object of the invention is to provide a gel-state detergent composition that has high fixability to the inner surface of the toilet bowl or the like and is readily squeezed out from the container.

### Solution to Problem

For achieving the object, the invention of claim 1 relates to a gel-state detergent composition containing cellulose nanofibers, a surfactant, and water.

According to the invention, a gel-state detergent composition that has high fixability to the inner surface of the toilet bowl or the like and is readily squeezed out from the container can be provided.

The invention of claim 2 relates to the gel-state detergent composition according to claim 1, wherein the gel-state detergent composition contains the cellulose nanofibers in an amount of 0.02% by mass or more and 0.2% by mass or less.

According to the invention, the fixability to the inner surface of the toilet bowl or the like can be higher, and the gel-state detergent composition can be further readily squeezed out from the container.

The invention of claim 3 relates to the gel-state detergent composition according to claim 1 or 2, wherein the cellulose nanofibers have an average fiber width of 30 nm or more and 50 nm or less.

According to the invention, the cleaning effect can be further enhanced.

The invention of claim 4 relates to a detergent product including the gel-state detergent composition according to any one of claims 1 to 3, stored in a squeezable container.

According to the invention, a detergent product having stored therein a gel-state detergent composition that has high fixability to the inner surface of the toilet bowl or the like and is readily squeezed out from the container can be provided.

### Advantageous Effects of Invention

According to the invention, a gel-state detergent composition that has high fixability to the inner surface of the toilet bowl or the like and is readily squeezed out from the container can be provided.

### BRIEF DESCRIPTION OF DRAWINGS

FIG. 1 is a perspective view showing one example of a squeezable container used for fixing a gel-state detergent containing a gel-state detergent composition according to one embodiment to an inner surface of a toilet bowl or the like.

FIG. 2 is a cross sectional view taken along the line II-II in FIG. 1.

FIG. 3A is a perspective view showing the gel-state detergent that is squeezed out to the inner surface of the toilet bowl or the like with the squeezable container shown in FIG. 1.

FIG. 3B is a cross sectional view taken along the line B-B in FIG. 3A.

FIG. 4 is a side view showing a squeezable container of a modified example. A part of the container body is omitted in the figure.

FIG. 5 is a plane view showing the squeezable container of the modified example.

### DESCRIPTION OF EMBODIMENTS

Specific examples of the gel-state detergent composition as embodiments of the invention will be described below.

### [Constituents of Gel-state Detergent Composition]

The gel-state detergent composition according to an embodiment of the invention is formed in a gel state and contains cellulose nanofibers (which are hereinafter referred to as “CNF”).

The term “gel-state” referred in the invention means that the composition is in a semisolid state with a definite form but does not become sol at 25° C.

### (CNF)

CNF mean fine cellulose fibers obtained through fibrillation of pulp fibers, and generally means cellulose fibers containing cellulose fine fibers having an average fiber width in a nano-order size (i.e., 1 nm or more and 1,000 nm or less).

Examples of the pulp fibers capable of being used for producing the CNF include chemical pulp, such as leaf bleached Kraft pulp (LBKP) and needle bleached Kraft pulp (NBKP), mechanical pulp, such as bleached thermomechanical pulp (BTMP), stone ground wood pulp (SGP), pressure ground wood pulp (PGW), refiner ground wood pulp (RGP), chemiground wood pulp (CGP), thermoground wood pulp (TGP), ground wood pulp (GP), thermomechanical pulp (TMP), chemithermomechanical pulp (CTMP), and refiner mechanical pulp (RMP), waste paper pulp produced from brown waste paper, Kraft envelope waste paper, journal waste paper, newspaper waste paper, flyer waste paper, office waste paper, cardboard waste paper, high-quality white waste paper, kent waste paper, imitation vellum waste paper, certificate waste paper, and ground wood waste paper, and deinked pulp (DIP) obtained through deinking treatment of waste paper pulp. These materials may be used alone or as a combination of plural kinds thereof unless the effects of the invention are impaired.

Examples of the production method of the CNF include a mechanical method, such as a high-pressure homogenizer method, a microfluidizer method, a grinder abrasion method, a bead mill freeze crushing method, and an ultrasonic fiberization method, and the production method is not limited to these methods.

For example, a material obtained through a fibrillation treatment of pulp fibers may be subjected to a chemical treatment, such as carboxymethylation, or may be subjected to an enzyme treatment.

Furthermore, the CNF subjected to a chemical treatment or an enzyme treatment may be subjected to a fibrillation treatment through a mechanical measure.

The CNF used in this embodiment preferably have a fiber width that relatively remains without excessive fibrillation, and specifically preferably have an average fiber width of 30 nm or more and 50 nm or less calculated by the method described later. The CNF having the feature can be obtained, for example, in the case where only the fibrillation treatment with a mechanical measure is performed, but no chemical treatment is performed. In this case, the CNF can be steric obstacles due to the shape thereof relatively remaining, and can increase the effect of enhancing the cleaning effect described later.

The content ratio of the CNF in the gel-state detergent composition is preferably 0.02% by mass or more and 0.2% by mass or less. In the case where a 2% by mass aqueous solution thereof is used, for example, this means that the aqueous solution is preferably added in an amount of 1% by mass or more and 10% by mass or less. With a content ratio of less than 0.02% by mass, the effect described later obtained by adding the CNF may not be sufficiently exhibited, and with a content ratio exceeding 0.2% by mass, the bubbling in production may be vigorous to make the production difficult. The content ratio thereof is most preferably 0.1% by mass or more and 0.16% by mass or less.

Specific examples of the CNF that can be actually usable include CNF containing 100% of NBKP having an average fiber width (median diameter) of CNF of 49 nm. The CNF are obtained by coarsely fibrillating NBKP through a refiner treatment and then fibrillating 4 times by subjecting to a high-pressure homogenizer.

The measurement method of the fiber width (average fiber width) of the CNF will be described.

100 mL of a water dispersion liquid of cellulose nanofibers having a solid concentration of from 0.01 to 0.1% by mass is filtered through a membrane filter formed of Teflon (trade name), and the solvent is replaced by 100 mL of ethanol once and by 20 mL of t-butanol 3 times.

The dispersion liquid is then freeze-dried and coated with osmium to prepare a specimen. The specimen is observed through an SEM image at a magnification of 5,000, 10,000, or 30,000 depending on the width of the constitutional fibers (the magnification is 30,000 for the CNF described in the paragraph 0021). Specifically, two diagonal lines are drawn in the observation image, and arbitrary three straight lines are drawn through the intersection point of the diagonal lines. The 100 fibers in total that cross the three straight lines are visually measured for the width of the fiber. The median diameter of the measured values is designated as the average fiber diameter. Not only the median diameter of the measured value, but also the number average diameter or the mode diameter thereof may be designated as the average fiber diameter.

### (Other Components)

The gel-state detergent composition may contain a surfactant, a perfume, glycerin, water, and the like, in addition to the CNF. Among these, the surfactant and water are essential.

The surfactant and water are essential for gelling the detergent. The surfactant used is preferably a nonionic surfactant, such as an ester type, an ether type, and an alkyl glucoside type.

The content ratio of the surfactant is preferably 10% by mass or more and 60% by mass or less. With a content ratio of less than 10% by mass, the composition may not be in a gel state, and with a content ratio exceeding 60% by mass, the composition may be in a solid state. The content ratio thereof is most preferably 30% by mass or more and 39% by mass or less.

The perfume may be added to impart a fragrance function to the gel-state detergent composition, in addition of the cleaning function.

The content ratio of the perfume is preferably 0.5% by mass or more and 10% by mass or less. With a content ratio of less than 0.5% by mass, the fragrance function may be frequently insufficient, and with a content ratio exceeding 10% by mass, the composition may not be in a gel state. The content ratio thereof is most preferably 3% by mass or more and 7% by mass or less.

Glycerin may be added for controlling the gelation concentration of the gel-state detergent composition.

The content ratio of glycerin is preferably 3% by mass or more and 20% by mass or less.

### [Effect of Gel-state Detergent Composition]

CNF have high thixotropy. Specifically, the viscosity thereof tends to decrease in receiving a shear stress, but the viscosity tends to increase in a standing still state.

Therefore, in the case where the user applies a force to the container for squeezing out the gel-state detergent composition therefrom, the viscosity of the composition is decreased to facilitate the squeezing operation of the gel-state detergent composition out from the container. After fixing the composition to the inner surface of the toilet bowl or the like, the viscosity thereof is increased to enhance the fixability, resulting in the exhibition of the cleaning effect for a long period of time.

CNF function as steric obstacles exhibiting the effect of enhancing the foamability, and thereby the cleaning effect of the gel-state detergent composition can be enhanced.

### Modified Example

The gel-state detergent composition may further contain carboxymethyl cellulose (which is hereinafter referred to as “CMC”).

The CMC is bonded to the OH group of the CNF, and thereby facilitates the dissociation of the molecules through steric hindrance by the electrostatic interaction, so as to prevent the aggregation of the CNF, resulting in the enhancement of the effect thereof.

In the case where the CMC is added to the gel-state detergent composition, the content ratio thereof is preferably 0.5% by mass or more and 10% by mass or less. With a content ratio of less than 0.5% by mass, the effect described later may not be sufficiently exhibited, and with a content exceeding 10% by mass, the gelation may become unstable, and the gel state may be difficult to retain. The content ratio thereof is most preferably 1% by mass or more and 5% by mass or less.

The gel-state detergent composition may further contain hydroxyethyl cellulose (which is hereinafter referred to as “HEC”). The HEC may provide the same effect as the CMC.

In the case where the HEC is added to the gel-state detergent composition containing the CNF, the content ratio thereof is preferably 0.5% by mass or more and 10% by mass or less. With a content ratio of less than 0.5% by mass, the effect described above may not be sufficiently exhibited, and with a content exceeding 10% by mass, the gelation may become unstable, and the gel state may be difficult to retain. The content ratio thereof is most preferably 1% by mass or more and 5% by mass or less.

The gel-state detergent composition according to the embodiment is not limited to the use on the inner surface of the toilet bowl, but may be widely used on sites where water regularly flows, such as the inside of a basin.

### [Description of Squeezable Container]

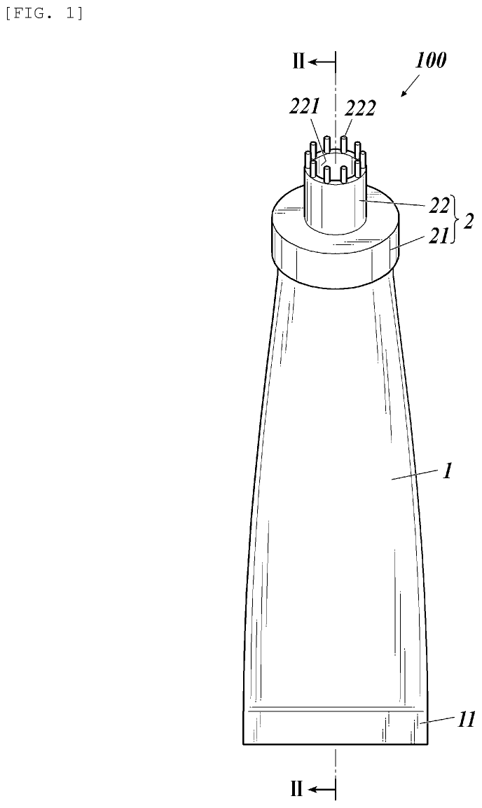

A squeezable container 100 used for fixing a gel-state detergent W containing the gel-state detergent composition according to the embodiment to an inner surface of a toilet bowl or the like will be described with reference to FIGS. 1 to 5. However, the squeezable container 100 is one example, and the configuration of the container used for fixing the gel-state detergent W containing the gel-state detergent composition according to the embodiment to an inner surface of a toilet bowl or the like is not limited thereto.

### {Configuration of Squeezable Container}

The squeezable container 100 includes a container body 1 and a discharge part 2 as shown in FIG. 1.

### (Container Body)

The container body 1 has an inner hollow cavity constituting a storage space S, which is filled with the gel-state detergent W, and constitutes the main portion of the squeezable container 100.

As shown in FIGS. 1 and 2, one end of the container body 1 is fused in a flat form to constitute a flat end 11. As shown in FIG. 2, the other end thereof forms an approximately circular opening to constitute a body side opening 12.

As shown in FIG. 2, the outer circumference of the body side opening 12 of the container body 1 has a circular shape that has approximately the same diameter as the inner circumference of a discharge part side opening 211 of the discharge part 2 described later, and the container body 1 is inserted to the discharge part side opening 211, so as to connect the container body 1 and the discharge part 2 by an arbitrary measure, such as adhesion with a prescribed adhesive.

It is also possible that the inner circumference of the body side opening 12 has a circular shape that has approximately the same diameter as the outer circumference of the discharge part side opening 211 of the discharge part 2 described later, and the discharge part 2 is inserted to the body side opening 12, so as to connect the container body 1 and the discharge part 2. However, for preventing the detachment in squeezing the gel-state detergent W, the members are preferably connected in the configuration shown in FIG. 2.

The container body 1 is formed of a softer material than the discharge part 2. The specific hardness thereof is preferably from 70 to 90. The hardness herein is measured according to JIS K6253 (type A durometer).

Specific examples of the material used include polyethylene terephthalate (PET), polypropylene (PP), aluminum, and various vapor-deposited films.

The size of the container body 1 may be arbitrarily determined depending on the amount of the gel-state detergent W to be filled, and is preferably formed in a size having a diameter of from 5 mm to 30 mm in the vicinity of the body side opening 12 and a length of from 50 mm to 150 mm from the flat end 11 to the body side opening 12 to make an internal capacity of from 30 mL to 100 mL, from the standpoint of the achievement of the internal capacity sufficient for multiple time use, and the achievement of the convenience in fixing the gel-state detergent W to the inner surface of the toilet bowl.

### (Discharge Part)

The discharge part 2 is a part that constitutes an opening, through which the gel-state detergent W is squeezed out, and includes a connecting part 21 and a projecting part 22 as shown in FIGS. 1 and 2.

The discharge part 2 is formed of a harder material than the container body 1. The specific hardness thereof is preferably from 90 to 100. The hardness herein is measured according to JIS K6253 (type A durometer).

Specific examples of the material used include PET and PP.

### (Connecting Part)

As shown in FIGS. 1 and 2, one end of the connecting part 21 forms an approximately circular opening to constitute the discharge part side opening 211.

As shown in FIG. 2, the inner circumference of the discharge part side opening 211 has a circular shape that has approximately the same diameter as the outer circumference of the body side opening 12 of the container body 1, and the container body 1 is inserted to the discharge part side opening 211, so as to connect the container body 1 and the discharge part 2 by an arbitrary measure, such as adhesion with a prescribed adhesive.

It is also possible that the outer circumference of the discharge part side opening 211 of the discharge part 2 has a circular shape that has approximately the same diameter as the inner circumference of the body side opening 12, and the discharge part 2 is inserted to the body side opening 12, so as to connect the container body 1 and the discharge part 2. However, for preventing the detachment in squeezing the gel-state detergent W, the members are preferably connected in the configuration shown in FIG. 2.

As shown in FIG. 2, the side of the connecting part 21 opposite to the discharge part side opening 211 has an opening only at the center thereof, and the projecting part 22 is connected to the opening.

The connecting part 21 has a slightly larger diameter than the vicinity of the container body 1 near the body side opening 12, and is formed in a cylindrical shape having a height of from 10 mm to 30 mm.

### (Projecting Part)

As shown in FIG. 2, the projecting part 22 is formed in a cylindrical shape, connected to the opening formed on the side of the connecting part 21 opposite to the side connected to the container body 1, and connected to the storage space S of the container body 1 through the connecting part 21. According to the configuration, the gel-state detergent W in the storage space S can be squeezed out through the interiors of the connecting part 21 and the projecting part 22.

The tip of the projecting part 22 has a circular discharge port 221, through which the gel-state detergent W is squeezed out, and plural protrusions 222 are formed on the periphery thereof. FIG. 1 shows the case where 10 protrusions 222 are formed, but the number of the protrusions 222 is not limited thereto. The protrusions 222 provided can regulate the shape of the gel-state detergent W fixed to the target surface, such as the inner surface of the toilet bowl, and can prevent the gel-state detergent W from being attached to the tip of the projecting part 22.

The discharge port 221 of the projecting part 22 preferably has a diameter of from 10 mm to 25 mm, and more preferably from 15 mm to 20 mm, for facilitating the squeeze of the gel-state detergent W and controlling the detergent to the appropriate size in pressing on the inner surface of the toilet bowl or the like, as described later.

The length of the projecting part 22 except for the protrusions 222 is preferably from 5 mm to 30 mm, and more preferably from 10 mm to 20 mm, for facilitating the pressing operation by securing the appropriate distance between the container body 1 and the inner surface of the toilet bowl in pressing the gel-state detergent W to the inner surface of the toilet bowl, as described later.

The protrusions 222 are preferably formed to protrude from the periphery of the discharge port 221 by from 0.5 mm to 5 mm, and more preferably from 1 mm to 3 mm, for exhibiting the aforementioned effects favorably. The distance among the protrusions 222 is preferably 1 mm or more in width for preventing the gel-state detergent W from being attached to the tip of the projecting part 22.

It is preferred that all the protrusions 222 are formed in the same length, and the tips thereof are positioned on one flat plane.

{Method for using Squeezable Container}

In using the squeezable container 100, firstly, the user holds the container body 1 and presses the same to make a state where the gel-state detergent W in the storage space S is squeezed out from the tip of the projecting part 22. At this time, the user controls the squeezed amount corresponding to the amount to be fixed to the inner surface of the toilet bowl or the like.

Subsequently, the user makes the side on the projecting part 22 of the squeezable container 100 in the state where the gel-state detergent W is squeezed out, proximate to the position of the inner surface of the toilet bowl or the like, to which the gel-state detergent W is to be fixed, and the gel-state detergent W in the squeezed out state is pressed on the position. At this time, the gel-state detergent W can be uniformly spread around the projecting part 22 by pressing while twisting.

At this time, the projecting part 22 is prevented from being directly into contact with the inner surface of the toilet bowl or the like.

Subsequently, the user draws the squeezable container 100 apart from the inner surface of the toilet bowl or the like. At this time, the gel-state detergent W squeezed out from the tip of the projecting part 22 is fixed on the inner surface of the toilet bowl or the like, and remains thereon.

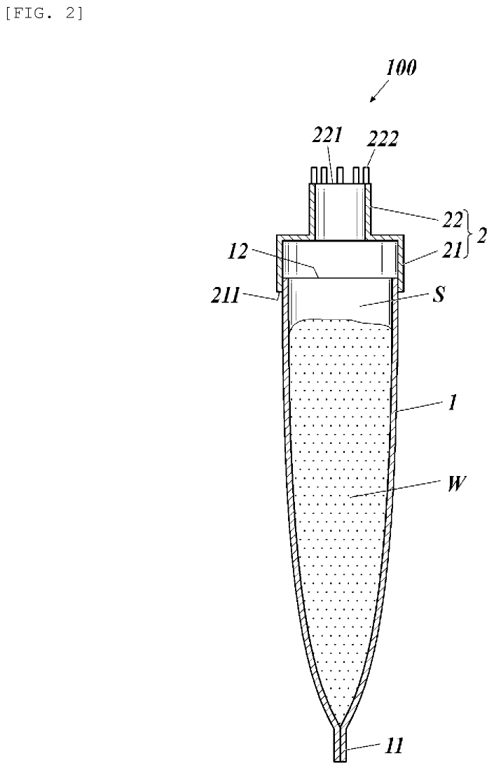

At this time, the gel-state detergent W can be uniformly spread around the projecting part 22, and the fixed amount thereof on the portion outside the projecting part 22 becomes large, whereas the fixed amount thereof on the portion overlapping the projecting part 22 becomes small. Accordingly, the gel-state detergent W fixed to the inner surface of the toilet bowl or the like has the shape shown in FIGS. 3A and 3B, in which a concave portion is formed at the center, and the periphery thereof protrudes to surround the entire circumference of the concave portion.

### [Effects of Squeezable Container]

According to the squeezable container 100, the gel-state detergent W can be fixed to inner surface of the toilet bowl or the like in the shape shown in FIGS. 3A and 3B as described above.

The surface of the detergent that is fixed to the inner surface of the toilet bowl or the like and is gradually dissolved out with flowing water is dried when the toilet is not used and water does not flow for a long period of time. In the case where the detergent is hardened through excessive drying, the detergent may not be dissolved out with flowing water of the toilet or the like and may lose the function as a detergent in some cases.

According to the squeezable container 100, however, the gel-state detergent W can be fixed to the inner surface of the toilet bowl or the like while making the concave portion formed at the center as described above, and thereby water tends to stay in the concave portion to prevent the fixed gel-state detergent W from being dried.

According to the squeezable container 100, the gel-state detergent W can be squeezed out and then can be fixed to the inner surface of the toilet bowl or the like only by pressing thereon, and therefore the fixing operation of the gel-state detergent W to the inner surface of the toilet bowl or the like can be readily performed.

According to the squeezable container 100, the gel-state detergent W is pressed onto the inner surface of the toilet bowl or the like in fixing the gel-state detergent W to the inner surface of the toilet bowl or the like. Accordingly, the gel-state detergent W immediately after fixing can be prevented from being detached. Furthermore, the gel-state detergent W can be securely fixed to a curved surface.

According to the squeezable container 100, the gel-state detergent W can be fixed without direct contact of the discharge part 2 with the inner surface of the toilet bowl or the like. Accordingly, excellent hygiene can be achieved.

According to the squeezable container 100, the gel-state detergent W can be squeezed out from the container in an arbitrary amount, and thus can be used while controlling the amount thereof fixed, depending on the period of time where the cleaning effect is to be continued.

According to the squeezable container 100, the gel-state detergent W is stored in the relatively soft container body 1, which enables to squeeze out the gel-state detergent W while deforming the container body 1, and thereby the amount of the unusable gel-state detergent W remaining in the container can be reduced.

### {Modified Example of Squeezable Container}

The tip shape of the projecting part 22 of the discharge part 2 is not limited to that having the protrusions 222. However, a shape having plural gaps on the circumference of the tip thereof is preferred. The distance of the gaps is preferably 1 mm or more in width for preventing the gel-state detergent W from being attached to the tip of the projecting part 22.

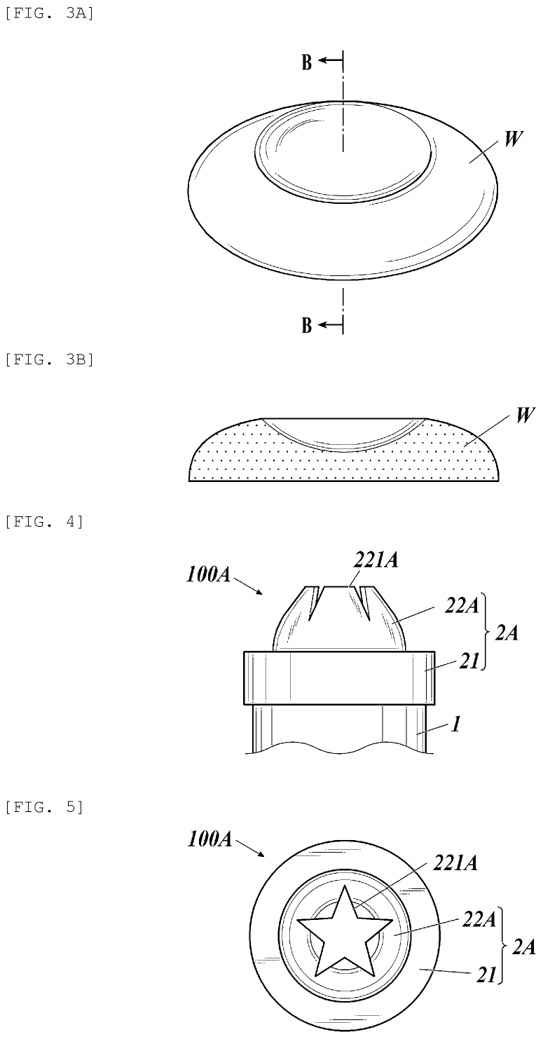

The shape of the projecting part is not limited to the cylindrical shape shown in FIGS. 1 and 2, and may be, for example, a projecting part 22A shown in FIGS. 4 and 5 having an approximately hemispherical shape with a discharge port 221A at the tip thereof. As for the shape of the discharge port 221A, a star-like shape in plane view is shown in FIGS. 4 and 5, but the shape thereof is not limited thereto. The surrounding area of the discharge port 221A preferably has a flat tip surface as shown in FIGS. 4 and 5 for stably retaining the gel-state detergent W squeezed out.

### EXAMPLES

The evaluation results for the fixability and the squeezability of the gel-state detergent compositions of the examples of the invention and the comparative example will be described.

### [Configurations of Examples and Comparative Example]

Gel-state detergent compositions of Examples and Comparative Example were prepared.

### Example 1

The gel-state detergent composition contained 35% by mass of a surfactant, 3% by mass of a perfume, 15% by mass of glycerin, 0.02% by mass of CNF (1% by mass of a 2% by mass aqueous solution), and 46.98% by mass of water.

The surfactant used was PC-2465 (produced by Miyoshi Oil & Fat Co., Ltd.).

The perfume used was Clean Floral (produced by Sakae Aromatic Co., Ltd.).

The glycerin used was concentrated glycerin (produced by New Japan Chemical Co., Ltd.).

The CNF used were those described in the paragraphs 0019 and 0020.

### Example 2

The gel-state detergent composition contained 35% by mass of a surfactant, 3% by mass of a perfume, 15% by mass of glycerin, 0.06% by mass of CNF (3% by mass of a 2% by mass aqueous solution), and 46.94% by mass of water, and the specifications of the components were the same as in Example 1.

### Example 3

The gel-state detergent composition contained 35% by mass of a surfactant, 3% by mass of a perfume, 15% by mass of glycerin, 0.1% by mass of CNF (5% by mass of a 2% by mass aqueous solution), and 46.9% by mass of water, and the specifications of the components were the same as in Example 1.

### Comparative Example 1

The gel-state detergent composition contained 35% by mass of a surfactant, 3% by mass of a perfume, 15% by mass of glycerin, 0% by mass of CNF, and 47% by mass of water, and the specifications of the components were the same as in Example 1.

### [Evaluation Methods]

The gel-state detergent compositions of Examples and Comparative Example were subjected to the following two evaluations.

### (Evaluation of Self-Fixability)

The gel-state detergent compositions of Examples and Comparative Example each were heated to 80° C. and stored in a squeezable container (a container for Scrubbing Bubbles Toilet Stamp Cleaner, produced by S.C. Johnson & Son, Inc.) in an amount of 40 mL, followed by cooling to room temperature (25° C.).

A square tile (an interior tile, produced by Lixil Corporation (former Inax Corporation) (Model No. SPKC-1060/L06KC), bottom dimension: 97 mm×97 mm, thickness: 5.0 mm) was divided into four square regions by drawing straight lines connecting the centers of the edges.

The gel-state detergent compositions were squeezed out with the containers to the four positions at the intersection points of the diagonal lines for the divided four square regions respectively. Specifically, the gel-state detergent composition according to Example 1 was squeezed out and fixed to one of the intersection points of the diagonal lines, the gel-state detergent composition according to Example 2 was squeezed out and fixed to another one of the intersection points of the diagonal lines, the gel-state detergent composition according to Example 3 was squeezed out and fixed to still another one of the intersection points of the diagonal lines, and the gel-state detergent composition according to Comparative Example 1 was squeezed out and fixed to yet another one of the intersection points of the diagonal lines, in an amount of 7 mL to make an approximately circular shape having a diameter of 30 mm.

Water (temperature: 12° C.) was poured onto the intersection point of the straight lines connecting the centers of the edges from a faucet at a height of 100 mm from the surface of the tile at a flow rate of 2 L/min, and the state after 10 minutes was evaluated.

Specifically, on the plane view of the tile, the case where the shape of the fixed gel-state detergent composition was not changed was evaluated as AA, the case where the area of the fixed gel-state detergent composition remained at 80% or more was evaluated as A, and the case where the area of the fixed gel-state detergent composition became 80% or less was evaluated as B.

### (Evaluation of Squeezability)

The gel-state detergent compositions of Examples and Comparative Example each were heated to 80° C. and stored in a squeezable container (a container for Scrubbing Bubbles Toilet Stamp Cleaner, produced by S.C. Johnson & Son, Inc.) in an amount of 40 mL, followed by cooling to room temperature (25° C.).

Five subjects each squeezed out the gel-state detergent composition from the squeezable container, and evaluated as to whether or not the subject felt the composition readily squeezable, and the number of subjects that felt readily squeezable was evaluated.

### (Evaluation Results)

The results of the evaluations are shown in Table 1.

TABLE 1

| | | Evaluation of |
|---|---|---|
| | Self-fixability | squeezability |
| Example 1 | A | 3/5 |
| Example 2 | A | 5/5 |
| Example 3 | AA | 5/5 |
| Comparative Example 1 | B | 0/5 |

### (Evaluation)

It is understood from the comparison between Examples 1 to 3 and Comparative Example 1 that the addition of the CNF to the gel-state detergent composition can enhance both the fixability and the squeezability from the container thereof.

It is understood from the comparison between Examples 1 and 2 and Example 3 that a content of the CNF of 0.1% by mass or more can further enhance the fixability.

It is understood from the comparison between Example 1 and Examples 2 and 3 that a content of the CNF of 0.06% by mass or more can further enhance the squeezability from the container.

### INDUSTRIAL APPLICABILITY

The invention can be favorably applied to the field of production of a gel-state detergent composition and a detergent product.

### REFERENCE SIGN LIST

100, 100A: squeezable container
1: container body
11: flat end
12: body side opening
2, 2A: discharge part
21: connecting part
211: discharge part side opening
22, 22A: projecting part
221, 221A: discharge port
222: protrusion
W: gel-state detergent
S: storage space

1-4. (canceled)

5. A gel-state detergent composition comprising:
cellulose nanofibers, a surfactant, and water.

6. The gel-state detergent composition according to claim 5, wherein the gel-state detergent composition comprises the cellulose nanofibers in an amount of 0.02% by mass or more and 0.2% by mass or less.

7. The gel-state detergent composition according to claim 5, wherein the cellulose nanofibers have an average fiber width of 30 nm or more and 50 nm or less.

8. A detergent product comprising the gel-state detergent composition according to claim 5, stored in a squeezable container.

9. The gel-state detergent composition according to claim 6, wherein the cellulose nanofibers have an average fiber width of 30 nm or more and 50 nm or less.

10. A detergent product comprising the gel-state detergent composition according to claim 6, stored in a squeezable container.

11. A detergent product comprising the gel-state detergent composition according to claim 7, stored in a squeezable container.
